(19) United States
(12) Patent Application Publication
(10) Pub. No.: US 2010/0077565 A1
(43) Pub. Date: Apr. 1, 2010

(54) HINGE CAPABLE OF BEING POSITIONED AT ANY ANGLE

(76) Inventor: Wei-Kuo Huang, Kaohsiung County (TW)

Correspondence Address: Wei-Kuo Huang, 235 Chung - Ho Box 8-24, Taipei, 235, TW

(21) Appl. No.: 12/243,969

(22) Filed: Oct. 1, 2008

(51) Int. Cl. E05D 11/08

(52) U.S. Cl. 16/342

(57) ABSTRACT

A hinge capable of being positioned at any angle, comprises a male hinge 1 having a penetrating axial hole 11 with a non-round cross section; a female hinge 2 having a receiving opening 20 for receiving the male hinge 1; each of two sides of the receiving opening 20 has a respective penetrating hole 21, 22; one penetrating hole 21 of the male hinge 1 having an inner thread 23 and a friction surface 24; a pivot shaft 3 capable of passing through the male hinge 1 and female hinge 2; a screwing element 4 positioned at one end of the pivot shaft 3; the screwing element 4 being coaxial to and non-rotatable with respect to the pivot shaft 3; the screwing element 4 being threaded to the inner thread; the pivot shaft 3 having a damping unit 32 which is adhered to the friction surface 24; the pivot shaft 3 being formed with an interact section 31; a cross section of the interact section 31 being identical to that the penetrating hole 11 of the male hinge 1.

### FIELD OF THE INVENTION

The present invention relates to hinges, and particularly to a hinge capable of being positioned at any angle which can be applied to windows of a boat so as to position a cover at any predetermined angle.

### BACKGROUND OF THE INVENTION

The hinge for a window of a boat has a male hinge and a female hinge. The hinge can be not positioned automatically as the window is opened with a predetermined angle so that a supporting rod is used to support a cover of the window. However this is inconvenient.

In one improvement structure, a crank is used to replace the supporting rod so as to position the window, but the crank is expensive and the operation is also inconvenient.

In another improvement, a tension spring is added to the hinge so that the hinge is positioned as it is opened to a predetermined angle. However the tension spring is flexible and compressible so that it is easy to be interfered by external factors, such as the vibration of the boat on the sea. Thus the structure is unstable. Furthermore, the fatigue of the spring will affect the function of the hinge.

In another design, a plastic sheet is added to the hinge. As the plastic sheet is compressed to deform and friction force is generated, which will have the effect in positioning. However since the sheet is at a compressing state, it is easy to deform, break, fatigue, and deterioration so that the flexibility of the sheet is reduced for a long time and thus the stability is reduced.

Therefore, there is an eager demand for a novel design which can cause the hinge can be positioned as a predetermined angle as it is opened. Furthermore, the structure is stable and simple and can be used to the windows of boats.

### SUMMARY OF THE INVENTION

Accordingly, the object of the present invention is to provide a hinge capable of being positioned at any angle, which has a simple structure and is stable. The hinge of the present invention is suitable to the window or opening of boats. To achieve above object, the present invention provides a hinge capable of being positioned at any angle, comprising: a male hinge having a penetrating axial hole with a non-round cross section; a female hinge having a receiving opening for receiving the male hinge; each of two sides of the receiving opening having a respective penetrating hole; one penetrating hole of the male hinge having an inner thread and a friction surface; a pivot shaft capable of passing through the male hinge and female hinge; a screwing element positioned at one end of the pivot shaft; the screwing element being coaxial to and non-rotatable with respect to the pivot shaft; the screwing element being threaded to the inner thread; the pivot shaft having a damping unit which is adhered to the friction surface; the pivot shaft being formed with an interact section; a cross section of the interact section being identical to that the penetrating hole of the male hinge. When the pivot shaft passes through the male hinge and female hinge; the screwing element will position the pivot shaft so that the damping unit is adhered to the friction surface to have a damping effect so as to form a hinge capable of being positioned at any predetermined angle.

The various objects and advantages of the present invention will be more readily understood from the following detailed description when read in conjunction with the appended drawing.

### BRIEF DESCRIPTION OF THE DRAWINGS

FIG. 1 is an assembled schematic view of the present invention.

FIG. 2 shows the male hinge of the present invention.

FIG. 3 is a left side view of FIG. 2.

FIG. 4 is a right side view of FIG. 2.

FIG. 5 is an elevation view of FIG. 2.

FIG. 6 shows the pivot shaft of the present invention.

FIG. 7 is a left side view of FIG. 6.

FIG. 8 is a right side view of FIG. 6.

FIG. 9 is a cross sectional view of FIG. 6.

FIG. 10 shows the female hinge of the present invention.

FIG. 11 is a left side view of FIG. 10.

FIG. 12 is a right side view of FIG. 10.

FIG. 13 is a cross sectional view of FIG. 10.

FIG. 14 is an assembled schematic view of the male hinge, female hinge and the pivot shaft.

FIG. 15 is a left side view of FIG. 14.

FIG. 16 is a right side view of FIG. 14.

FIG. 17 is a cross sectional view of FIG. 14.

FIG. 18 is a schematic view showing that an openable and non-horizontal arrangement of the present invention.

FIG. 19 is a schematic view showing that an openable and horizontal arrangement of the present invention.

FIG. 20 shows the use of the present invention.

FIG. 21 is right enlarged schematic view of the hinge in FIG. 20.

FIG. 22 shows another use of the present invention.

FIG. 23 is a right enlarged schematic view of the hinge in FIG. 22.

FIG. 24 is an assembled schematic view of another embodiment of the present invention.

FIG. 25 is an assembled schematic view of FIG. 24.

FIG. 26 is a left side view of FIG. 24.

FIG. 27 is a right side view of FIG. 24.

FIG. 28 is a cross sectional view along line 28-28 in FIG. 24.

FIG. 29 is a cross sectional view along line 29-29 of FIG. 24.

FIG. 30 shows a use according to the embodiment in FIG. 24.

FIG. 31 is a left enlarged schematic view of FIG. 30.

FIG. 32 shows the use of the embodiment in FIG. 24.

FIG. 33 shows the use about the embodiment in FIG. 24.

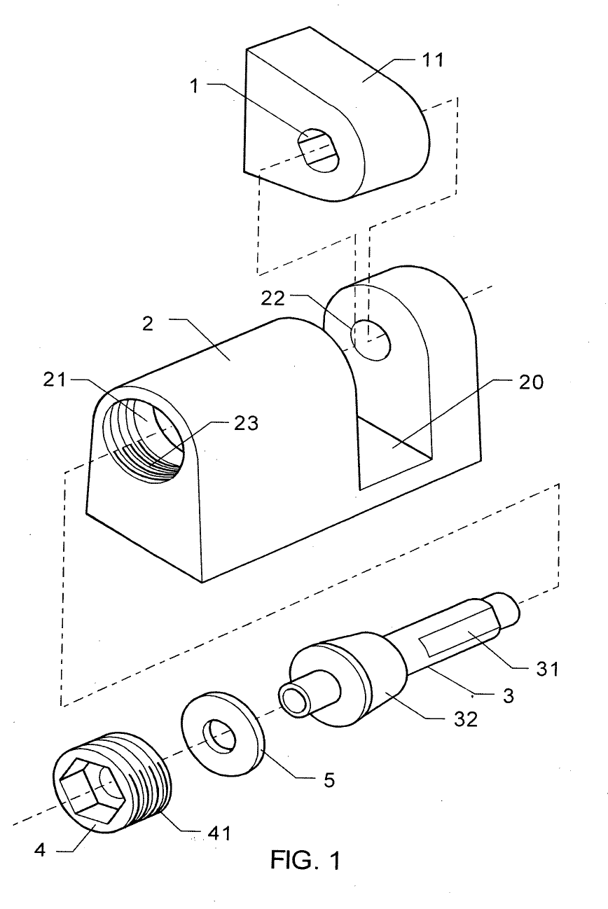

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

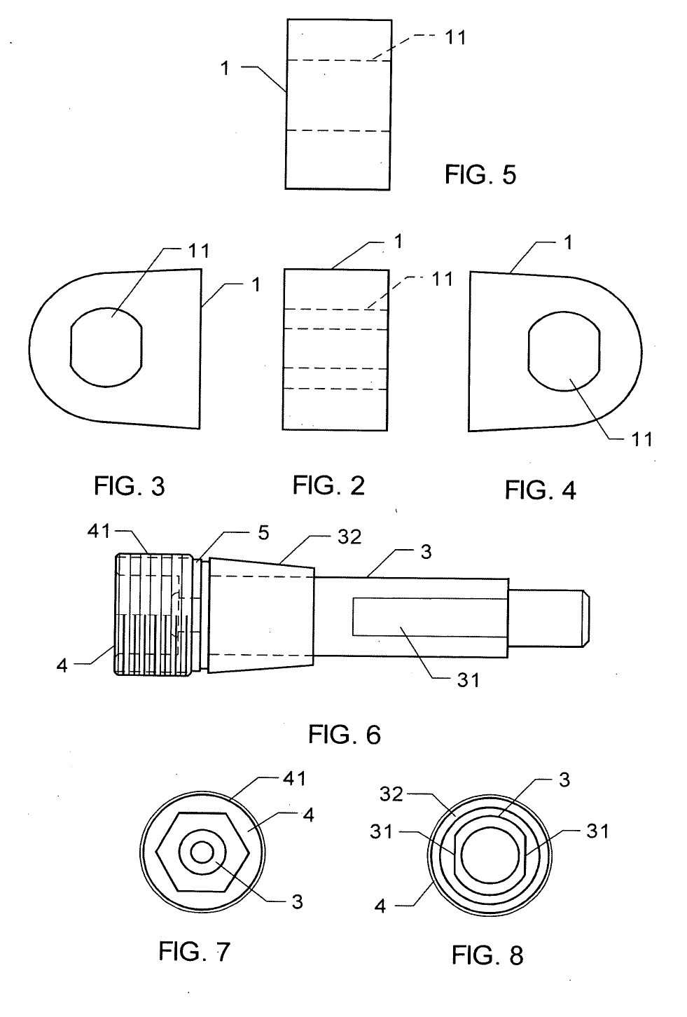

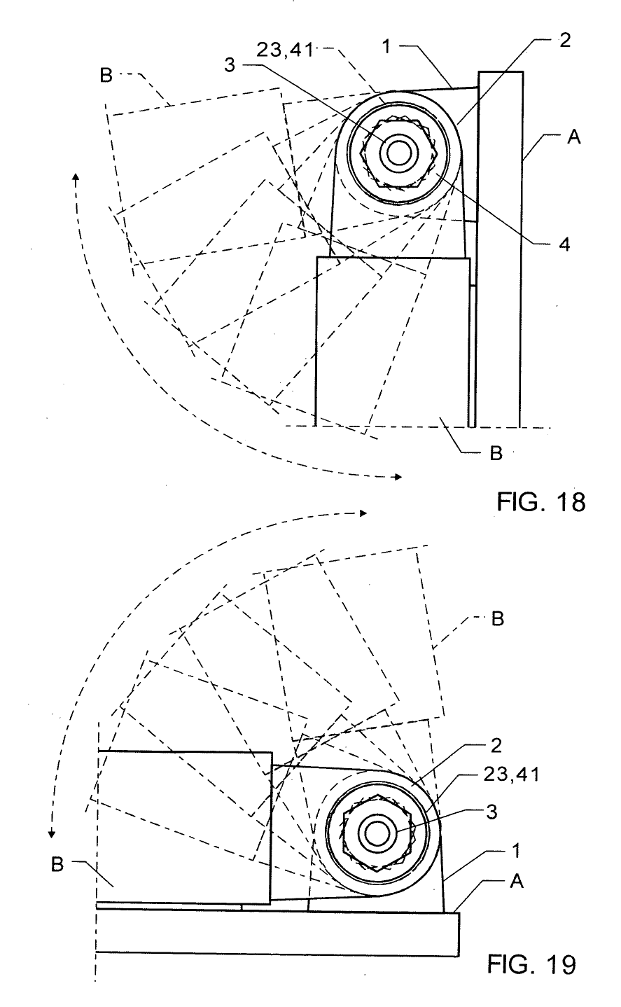

A male hinge 1 has a penetrating axial hole 11 with a non-round cross section. The male hinge 1 is fixed to a base A (referring to FIG. 18). The male hinge 1 has a penetrating hole 11. A cross section of the male hinge 1 is a non-round shape (referring to FIGS. 2 to 5).

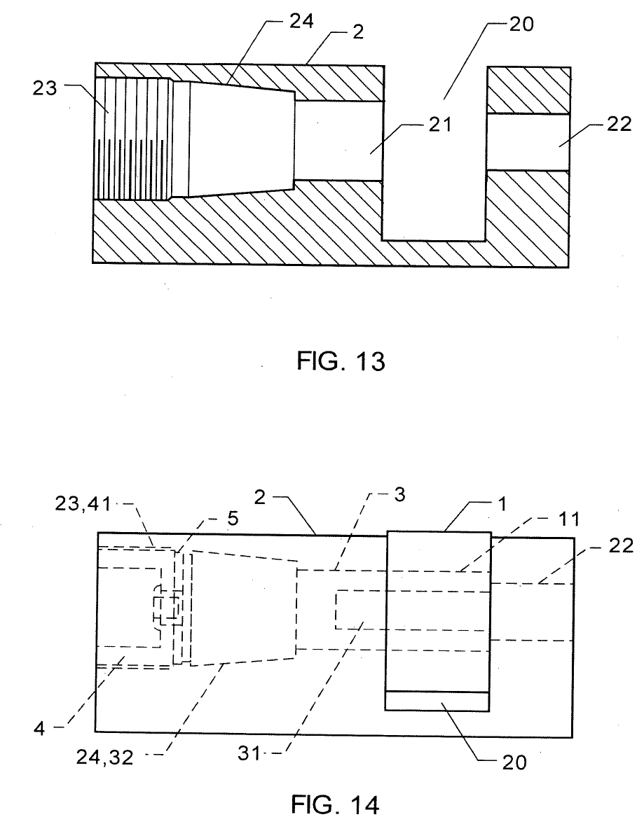

A female hinge 2 has a receiving opening 20 is fixed to an openable cover B (referring to FIG. 18). The female hinge 2 has a receiving opening 20 for receiving the male hinge 1. Two sides of the female hinge 2 aside the receiving opening 20 have respective penetrating holes 21, 22. One penetrating hole 21 has inner thread 23 and a friction surface 24 (referring to FIGS. 10 to 13).

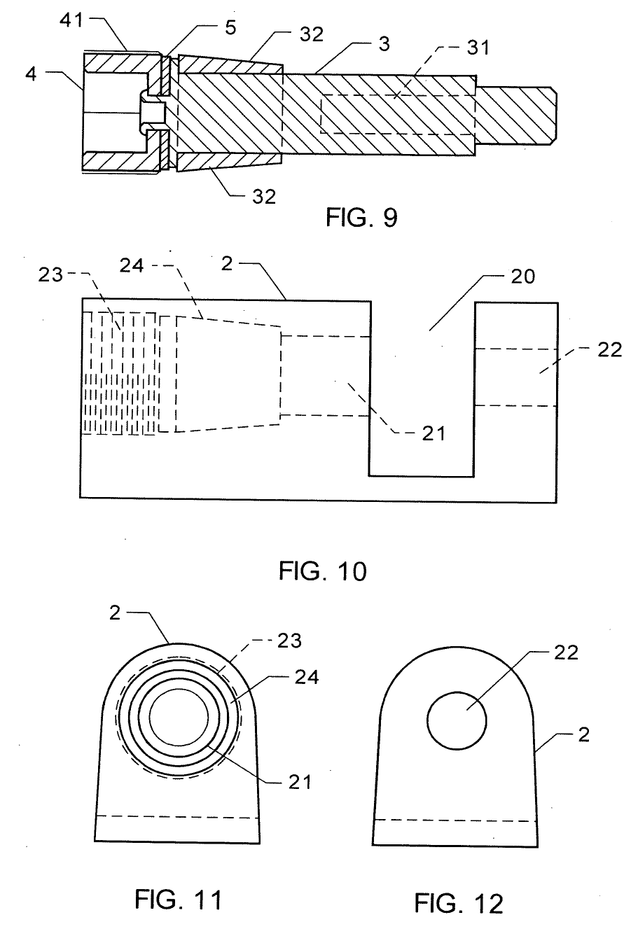

Referring to FIGS. 6 to 9, the pivot shaft 3 is a stud for assembly the male hinge 1 and the female hinge 2. One end of the pivot shaft 3 is positioned with a screwing element 4 with outer thread 41. The screwing element 4 is coaxially and riveted to the pivot shaft 3. The screwing element 4 is not rotated with respect to the pivot shaft 3. An axial body of the pivot shaft 3 is installed with an interact section 3 1 which has a cross section as that of the penetrating hole 11 of the male hinge 1 and a damping unit 32 capable of adhering to the friction surface 24. The damping unit 32 has made of a material as the barking sheet. The screwing element 4 is assembled to the inner thread 23. Another end of the pivot shaft 3 is positioned to the penetrating hole 22. The screwing operation of the screwing element 4 will move the pivot shaft 3 so that the damping unit 32 and the friction surface 24 has a preferred damping effect.

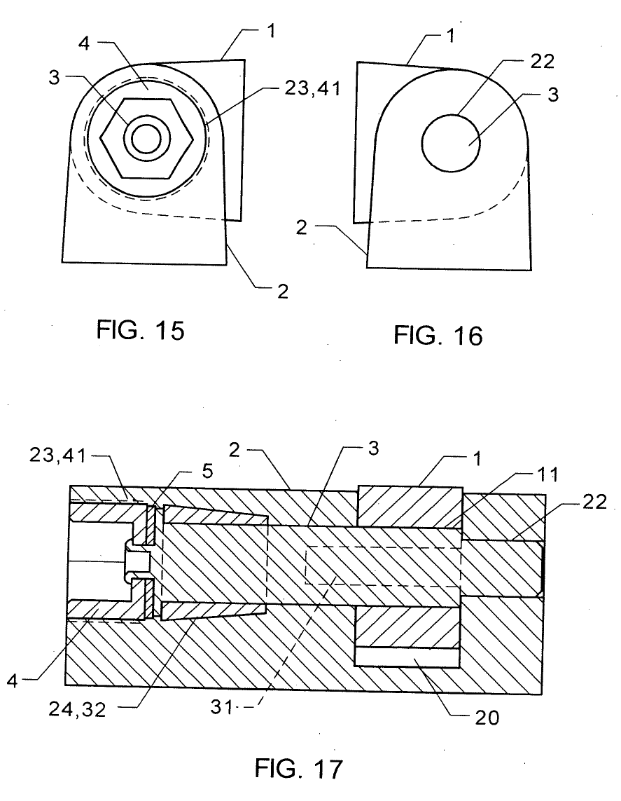

Referring to FIGS. 14 to 17, the pivot shaft 3 penetrates through the female hinge 2 and the male hinge 1. The interact section 31 of the pivot shaft 3 is engaged to the penetrating hole 11 so that pivot shaft 3 is reacted by the male hinge 1 and is not interacted with the female hinge 2. The screwing element 4 is interacted with the female hinge 2. When the screwing element 4 positions the pivot shaft 3. The damping unit 32 is adhered to the friction surface 24 so as to have a preferred damping effect. Thus, the present invention provides a simple and firm structured hinge.

Referring to FIG. 18, it provides an openable and non-horizontal hinge. In FIG. 19, an openable and horizontal hinge is provided. The male hinge 1 is fixed to an openable base A. The female hinge 2 is fixed to an openable cover B. The pivot shaft 3 passes through the penetrating holes of the male hinge 1 and the female hinge 2. When the cover B is opened, the damping unit 32 will rub the friction surface 24 so as to be performed at a predetermined angle.

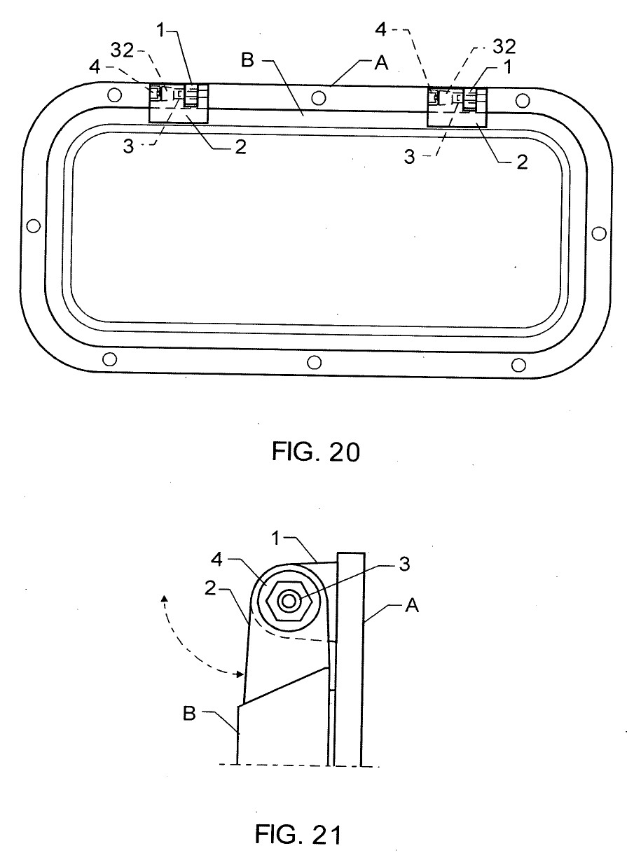

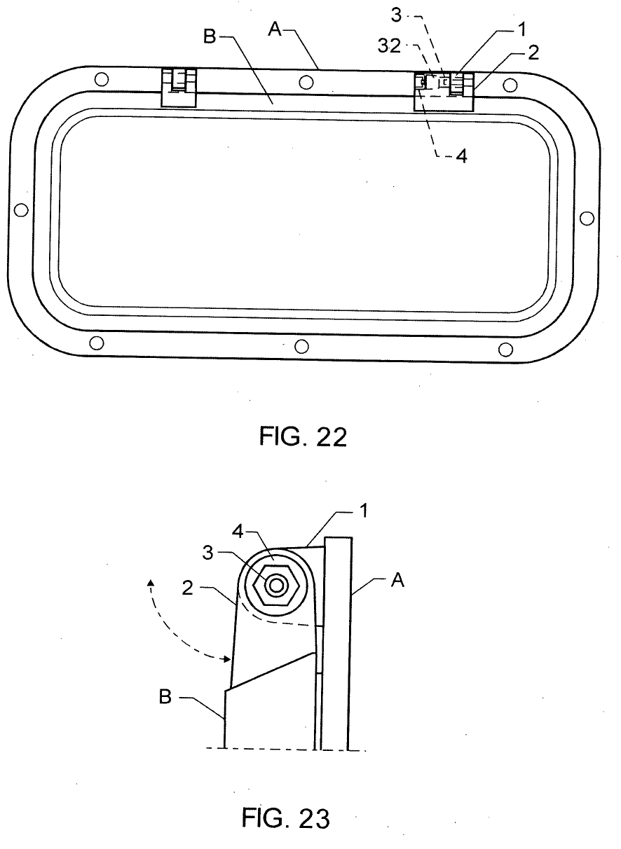

Referring to FIGS. 20 and 21, it is illustrated that in the present invention, two sets of hinges are used to a window of a boat. The male hinges I are fixed to the base A. The male hinges 1 are fixed to the cover B. However as illustrated in FIGS. 22 and 23, the hinge of the present invention can be used with other prior art used hinge.

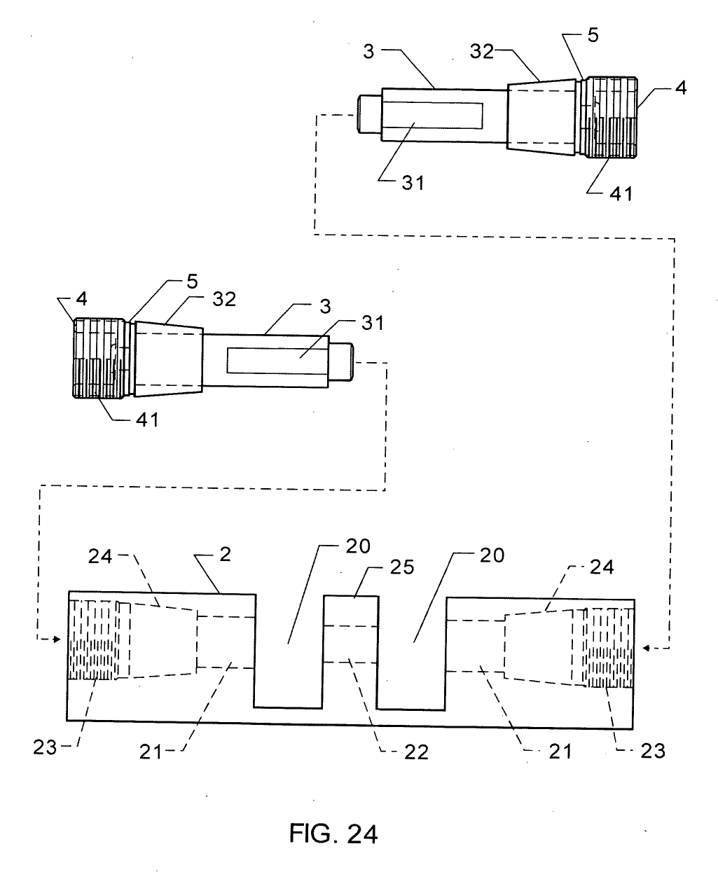

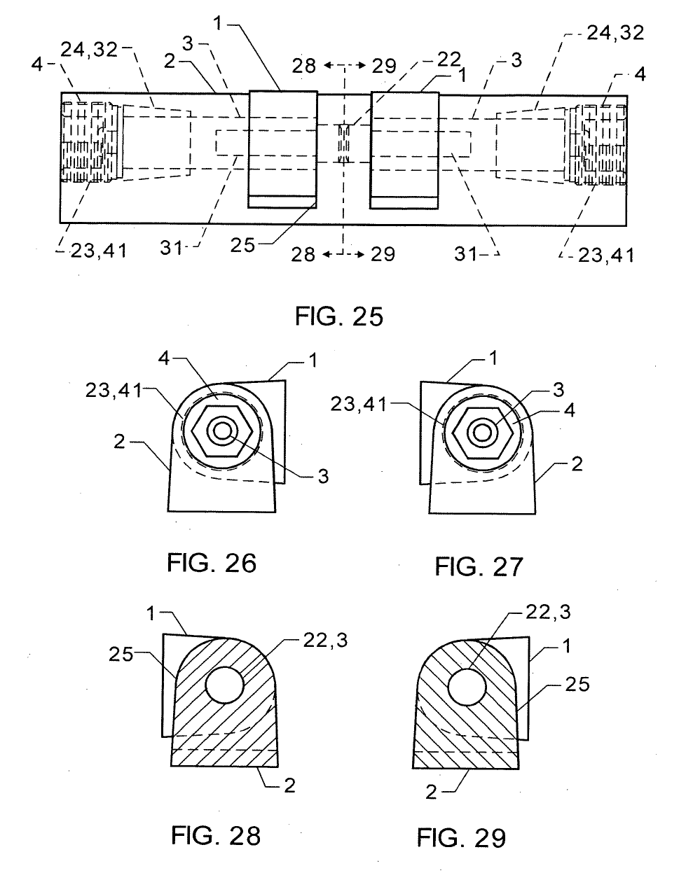

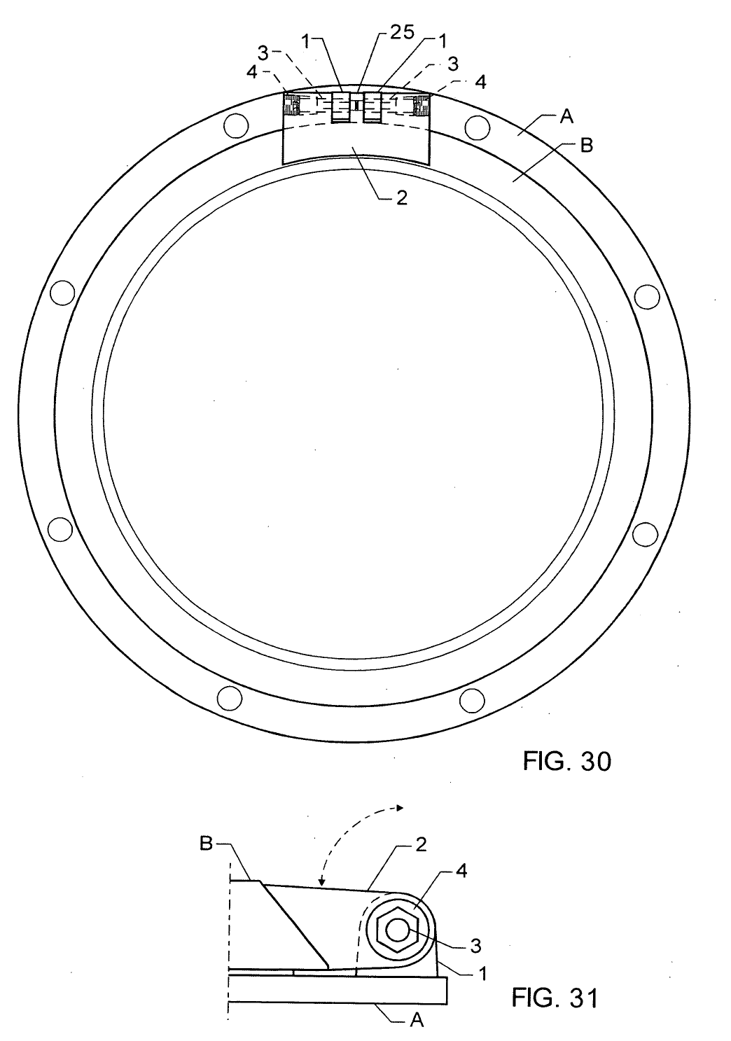

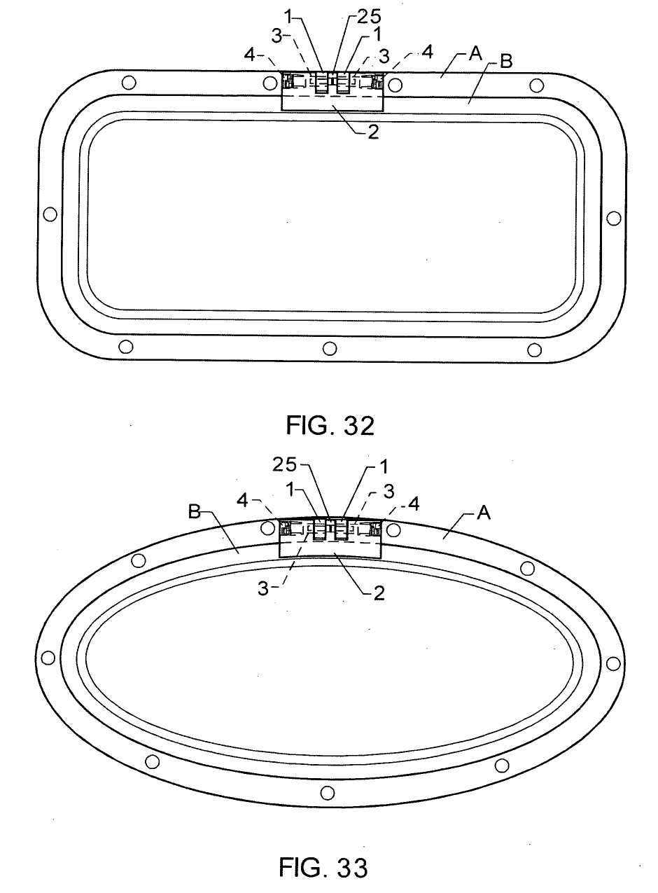

Referring to FIGS. 24 to 29, another embodiment of the present invention is illustrated. The male hinge 1 has two receiving openings 20 which can receive at least two male hinges 1. An isolation wall 25 is formed between the two receiving openings 20. The isolation wall 25 is installed with a second penetrating hole 22. Another wall of each receiving opening 20 has a first penetrating hole 21. An outer side of the first penetrating hole 21 has inner thread and friction surface 24 (referring to FIG. 24). Each receiving opening 20 is penetrated by a respective pivot shaft 3 so as to engage with a respective male hinge 1. Thus the objects illustrated from FIG. 30 and FIG. 33 are achieved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hinge capable of being positioned at any angle, comprising: a male hinge having a penetrating axial hole with a non-round cross section;
a female hinge having a receiving opening for receiving the male hinge; each of two sides of the receiving opening having a respective penetrating hole; one penetrating hole of the male hinge having an inner thread and a friction surface;
a pivot shaft capable of passing through the male hinge and female hinge; a screwing element positioned at one end of the pivot shaft; the screwing element being coaxial to and non-rotatable with respect to the pivot shaft; the screwing element being threaded to the inner thread; the pivot shaft having a damping unit which is adhered to the friction surface; the pivot shaft being formed with an interact section; a cross section of the interact section being identical to that the penetrating hole of the male hinge; and
wherein when the pivot shaft passes through the male hinge and female hinge; the screwing element will position the pivot shaft so that the damping unit is adhered to the friction surface to have a damping effect so as to form a hinge capable of being positioned at any predetermined angle.

2. The hinge capable of being positioned at any angle as claimed in claim 1, wherein the damping unit is made of a material of a braking sheet.

3. The hinge capable of being positioned at any angle as claimed in claim 1, wherein the screwing element is movable along the inner thread so as to generate a damping affect between the damping unit and the friction surface.

4. The hinge capable of being positioned at any angle as claimed in claim 1, wherein when the pivot shaft passes through the male hinge and female hinge; the interact section of the pivot shaft is engaged to the penetrating hole of the male hinge so as to be interacted with the male hinge, but it do not interact with the female hinge, the screwing element at one end of the pivot shaft is interacted with the male hinge; when the screwing element positions the pivot shaft; the damping unit will adhere to the friction surface so as to have damp effect.

5. A hinge capable of being positioned at any angle, comprising: at least two male hinges each having a penetrating axial hole with a non-round cross section;
a female hinge having two receiving openings for receiving the male hinges; the two receiving openings being isolated by an isolation wall; the isolation wall having a first penetrating hole opened at two receiving openings; each receiving opening having a second penetrating hole at a side opposite to the side having the receiving opening of the isolation wall; an outer side
an outer side of each second penetrating hole of the male hinge having an inner thread and a friction surface;
two pivot shafts each capable of passing through the male hinge and female hinge; one end of the pivot shaft being positioned with a screwing element; the screwing element being coaxial to and non-rotatable with respect to the pivot shaft; the, screwing element being threaded to the respective inner thread; each pivot shaft having a respective damping unit which is adhered to the respective friction surface; each pivot shaft being formed with an interact section at a side opposite to the side having the screwing element; a cross section of the interact section being identical to that the penetrating hole of the male hinge; and
wherein when each pivot shaft passes through the male hinge and female hinge; each screwing element will position the respective pivot shaft so that the respective damping unit is adhered to the respective friction surface to have a damping effect so as to form a hinge capable of being positioned at any predetermined angle.

6. The hinge capable of being positioned at any angle as claimed in claim 5, wherein the damping unit is made of a material of a braking sheet.

7. The hinge capable of being positioned at any angle as claimed in claim 5, wherein the screwing element is movable along the inner thread so as to generate a damping affect between the damping unit and the friction surface.

8. The hinge capable of being positioned at any angle as claimed in claim 5, wherein when the pivot shaft passes through the male hinge and female hinge; the interact section of the pivot shaft is engaged to the penetrating hole of the male hinge so as to be interacted with the male hinge, but it do not interact with the female hinge, the screwing element at one end of the pivot shaft is interacted with the male hinge; when the screwing element positions the pivot shaft; the damping unit will adhere to the friction surface so as to have damp effect.
